(19) United States
(12) Patent Application Publication
(10) Pub. No.: US 2007/0061743 A1
(43) Pub. Date: Mar. 15, 2007

(54) Customization of visual editing elements

(75) Inventor: Nadav Golbandi, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/227,690

(22) Filed: Sep. 15, 2005

(51) Int. Cl. G06F 17/00; G06F 3/00

(52) U.S. Cl. 715/763; 715/810

(57) ABSTRACT

A tool for providing visual editing elements is provided in the form of a pallet with customizable entries. The pallet entries are a plurality of base prototypes (311) of elements, each base prototype providing meta-data properties of the element. At least one sub-prototype (312) is associated with a base prototype (311) with defined meta-data properties. The sub-prototype (312) is selectable by a user to create an element instance (313). An element instance may also be added as a new sub-prototype (313).

### FIELD OF THE INVENTION

This invention relates to the field of visual editing elements in graphical user interfaces (GUI). In particular, this invention relates to customization of user selectable visual editing elements.

### BACKGROUND OF THE INVENTION

In the domain of graphical user interfaces (GUIs), visual editors are software applications which enable a user to create and edit visual document. Visual editing components can be selected through menu choices, buttons, icons, etc. A pallet is a commonly-used on-screen building block (or widget) which enables a user to select a visual editing tool or element before interacting with a drawing edit area.

A pallet in the area of GUIs refers to an on-screen collection of pallet entries (typically icons or buttons), which represent various functionality or tools available to the user. In the common scenario, the pallet of a visual editor provides entries for a variety of primitives, which are used to build up the document.

For example, a freeform diagram editor may provide a pallet of shape entries (such as triangles, rectangles, circles, etc.). The user selects an entry (for example, a rectangle in a diagram editor) and then proceeds to the edit area on the display (the canvas). All interaction with the drawing area would now be in the context of that tool selection, so in this example clicking and dragging the mouse would create a rectangle element on the edit area. This context is preserved until a different tool selection is made. In some visual editors, the interaction is enabled by dragging the pallet entry directly into the edit area. Thus, dragging the rectangle shape with the mouse and releasing the button at a specific point in the edit area would result in the creation of a new rectangle element at that location of the edit area.

The set of primitives depends on the domain of the application. In a Computer-Aided Software Engineering (CASE) tool, for example, a pallet of primitives of the Unified Modeling Language is likely to be available.

The term pallet arises from the similarity to a pallet of colors available to an artist; however, it should not be confused with the term pallet from the domain of video display devices, where it explicitly represents colors. Depending on their domain, some applications refer to pallets by other names, including stencils, primitives, prototypes, toolboxes, etc.

Although pallets occur in most visual editors, they are typically static: the same entries are available throughout the life of the program. In some visual editors, entries can be added and removed to the pallet, but they are never changed. Since pallets consume precious screen space, the offerings of each pallet must be carefully selected. A visual editor may offer multiple pallets, but each would typically provide truly different primitives (for example, an oval and a rectangle). It is rare to see a simple variation of an existing entry, such as a rectangle with solid borders as well as one with dashed ones, since these can easily be created from the original rectangle. Some visual editors use expandable pallet entries, which can open a drop-down list of additional entries. Still, these entries are rarely overlapping.

In visual editors, elements on the edit area have properties, which are divided into context-dependent and context-independent properties. Context-dependent properties depend on the properties of other elements or the nature of the edit area. These include, for example, the location of the element on the edit area or the elements it is connected to. The context-independent properties are encapsulated within the object, such as its color, other visual characteristics, contents, labels, etc.

In accomplishing visual editing tasks, users often use context-independent characteristics to identify logical classes of elements. For example, a user creating a road map using a general-purpose drawing editor might use line shapes to represent roads, and use color and line thickness to distinguish state roads from interstates. Since general-purpose tools were not designed for this specific use, the pallet is likely to include simple lines. The user will create a solid black line on the edit area, and then customize it to the appropriate thickness and color. To create a second road of the same kind, the user has several options: create a new line and customize it the same way; copy the existing line and change its context-dependent properties (i.e. attach it to different objects); or use a “style brush” type of tool to copy visual properties (or style) into the new object. What is common to all these solutions is that they are essentially a form of implicit prototyping—using existing elements in the edit area to create new ones with the same context-independent properties.

Interaction using implicit prototyping is cumbersome. For example, if the user moves to a different area of the edit area and needs to create a new element based on the prototype, she must first scroll back to where the original elements were placed, find an appropriate prototype, copy it, move back to the new area, and paste it. It is not uncommon to see a user copying parts of existing diagrams into new diagrams in order to use elements from that diagram as prototypes.

Another disadvantage of implicit prototyping is its effect on collaboration, maintenance, and usability. Another user of the document will not know what primitives were actually used, thus risking divergence from the inherent semantics of the document. Specializing the general-purpose drawing tool would also be implicit, for example by providing a template document with a variety of shapes ready for prototyping.

### SUMMARY OF THE INVENTION

This invention is an interaction technique in the area of visual editors. Specifically, it enhances the functionality of a pallet. Whereas known pallets are typically static and provide a fixed set of options for each pallet entry, the invention provides an interaction technique for extending this set at runtime with customized prototypes, essentially allowing users to add routinely-used prototypes to the pallet.

According to a first aspect of the present invention there is provided a system for providing visual editing elements. The system comprises a base prototype of an element including meta-data properties of the element, and at least one sub-prototype associated with the base prototype with defined meta-data properties. The sub-prototype is selectable by a user to create an element instance.

In an embodiment of the present invention, the system includes means to add an element instance as a new sub-prototype. New sub-prototypes may be stored in the system, or may be stored in association with a current document in which the element instances are created.

The base prototype may be selectable by a user and one of the sub-prototypes may be provided as a default sub-prototype. The meta-data may be context-independent properties of an element. The sub-prototypes may be configurable to create an element instance. The sub-prototypes may be complex forms made up more than one base element. Different sets of meta-data properties may be provided for a base prototype.

According to a second aspect of the present invention there is provided a tool for providing visual editing elements, comprising a plurality of base prototypes of elements, each base prototype providing meta-data properties of the element, and at least one sub-prototype associated with the base prototype with defined meta-data properties. The sub-prototype is selectable by a user to create an element instance.

The tool may be a graphical user interface component, for example, a toolbar. The base prototypes may have an expanding means to show representations of the at least one sub-prototype.

According to a third aspect of the present invention there is provided a method for providing visual editing elements, comprising providing a base prototype of an element including meta-data properties of the element, providing at least one sub-prototype associated with the base prototype with defined meta-data properties, and selecting a sub-prototype to create an element instance.

The method may include means for adding an element instance as a new sub-prototype. The method may include selecting the base prototype and defaulting to one of the sub-prototypes. The method may further include configuring the sub-prototypes to create an element instance.

According to a fourth aspect of the present invention there is provided a computer program product stored on a computer readable storage medium, comprising computer readable program code means for performing the steps of providing a base prototype of an element including meta-data properties of the element, providing at least one sub-prototype associated with the base prototype with defined meta-data properties, and selecting a sub-prototype to create an element instance.

Each pallet entry represents one base prototype as before; however, each entry is expandable (e.g. by a pull-down menu brought on by a mouse click) into a list of available sub-prototypes which can be selected and dragged to the edit area as usual. The resulting element is equivalent to instantiating an element from the base prototype and then applying a specific set of certain context-independent properties. In addition, a user can add a new sub-prototype to the pallet by selecting an element with a specific set of context-independent properties. The user-customized sub-prototypes can saved with the document, or with the application for use in other documents.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a computer system in which the present invention may be implemented;

FIG. 2 is a representation of a computer display showing a visual editor application in accordance with the present invention;

FIG. 3A is a schematic diagram of a prototype based instance as known in the prior art;

FIG. 3B is a schematic diagram of a sub-prototype based instance in accordance with the present invention;

FIG. 4 is a diagram showing the three levels of a pallet entry in accordance with the present invention; and

FIG. 5 is a flow diagram of a method of using the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

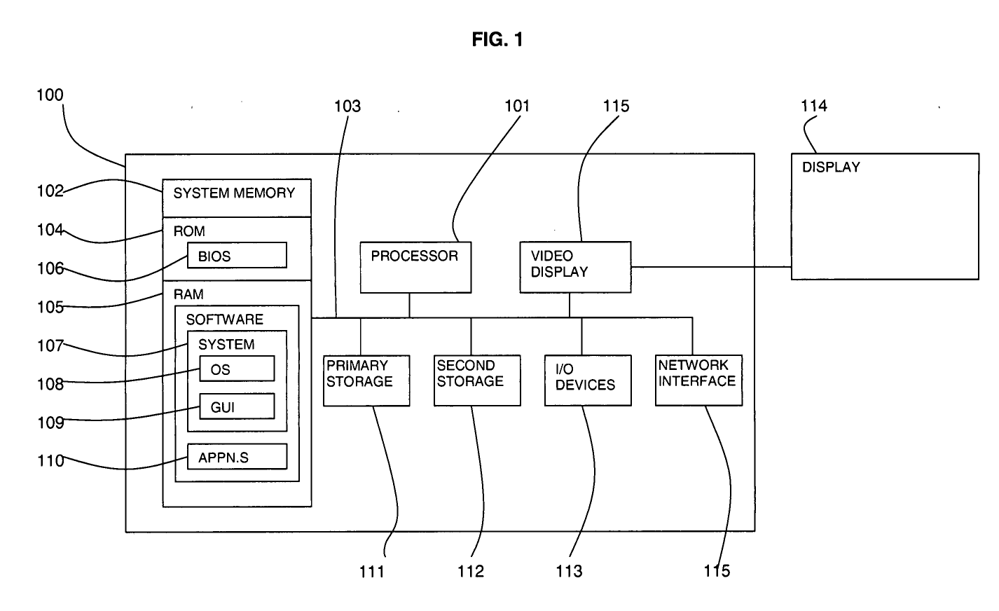

Referring to FIG. 1, an exemplary system for implementing the invention includes a data processing system 100 suitable for storing and/or executing program code including at least one processor 101 coupled directly or indirectly to memory elements through a bus system 103. The memory elements can include local memory employed during actual execution of the program code, bulk storage, and cache memories which provide temporary storage of at least some program code in order to reduce the number of times code must be retrieved from bulk storage during execution.

The memory elements may include system memory 102 in the form of read only memory (ROM) 104 and random access memory (RAM) 105. A basic input/output system (BIOS) 106 may be stored in ROM 104. System software 107 may be stored in RAM 105 including operating system software 108 and graphical user interfaces (GUIs) 109. Software applications 110 may also be stored in RAM 105.

The system 100 may also include a primary storage means 111 such as a magnetic hard disk drive and secondary storage means 112 such as a magnetic disc drive and an optical disc drive. The drives and their associated computer-readable media provide non-volatile storage of computer-executable instructions, data structures, program modules and other data for the system 100. Software applications may be stored on the primary and secondary storage means 111, 112 as well as the system memory 102.

The computing system 100 may operate in a networked environment using logical connections to one or more remote computers via a network adapter 116.

Input/output devices 113 can be coupled to the system either directly or through intervening I/O controllers. A user may enter commands and information into the system 100 through input devices such as a keyboard, pointing device, or other input devices (for example, microphone, joy stick, game pad, satellite dish, scanner, or the like). Output devices may include speakers, printers, etc. A display device 114 is also connected to system bus 103 via an interface, such as video adapter 115.

GUIs provide means for a user to perform tasks. They usually make use of a pointing device such as a mouse by means of which a pointer is moved around the monitor screen. Clicking a button on the mouse initiates an operation.

Applications generally run in their own areas called windows. Visual editor applications generally provide one or more pallets implemented in the form of toolbars or other GUI concepts displayed in the window. In addition, pull-down menus provide access to functions of the application. An edit area for a document can be displayed in the remainder of the window.

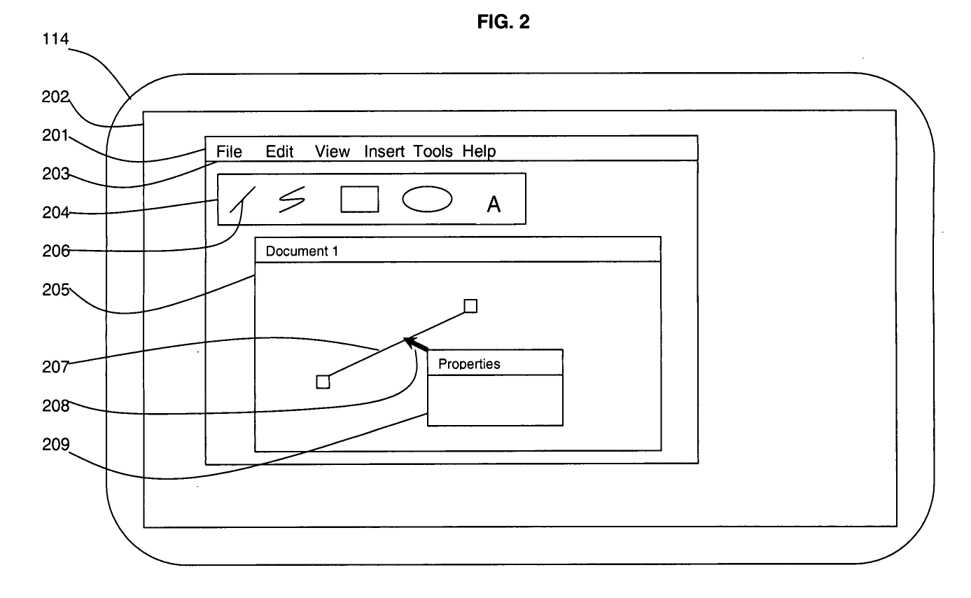

Referring to FIG. 2, a visual editor application 201 is shown displayed on a desktop 202 of a display device 114. The visual editor application 201 may be maximized to fill the whole desktop 202 display area, or may be provided in a smaller window within the desktop 202 to allow access to other icons on the desktop 202.

The visual editor application 201 includes a pull-down menu 203 and a pallet 204 (for example, as shown implemented as a toolbar). The visual editor 201 also includes an edit area 205 for a document currently being created or edited. More than one edit area 205 may be open at the same time on the desktop 202. The pallet 204 provides prototypes 206 for elements to be created in the edit area 205. For example, FIG. 2 shows prototypes 206 for a line, a rectangle, an oval, and a text box.

An element 207 is shown in the edit area 205 in the form of a line. When an element 207 is selected by a pointer 208 operated by the user, it is highlighted by some means. In this example, the selected element 207 has small squares at its ends. When an element 207 is selected by a pointer, a menu of properties 209 specific to the element 207 can be activated to customize the selected element 207.

A pallet provides an on-screen collection of visual editing elements, which represent various tools and components available to the user. A visual editor application may offer multiple pallets each providing different entries. Some visual editor applications use expandable pallet entries, which can open a drop-down list of additional entries. A pallet of a visual editor application provides entries for a variety of prototypes in the form of basic examples of types of element.

The user selects a prototype from the pallet and then proceeds to the edit area on the display. All interaction with the edit area is then in the context of that prototype selection. This context is preserved until a different prototype or tool selection is made. In some visual editor applications, the interaction is enabled by dragging the pallet entry directly into the edit area.

In visual editor applications, elements on the edit area have properties, which are divided into context-dependent and context-independent properties. Context-dependent properties depend on the properties of other elements or the nature of the edit area. These include, for example, the location of the element on the edit area or the elements it is connected to. The context-independent properties are encapsulated within the object, such as its color, other visual characteristics, contents, labels, etc.

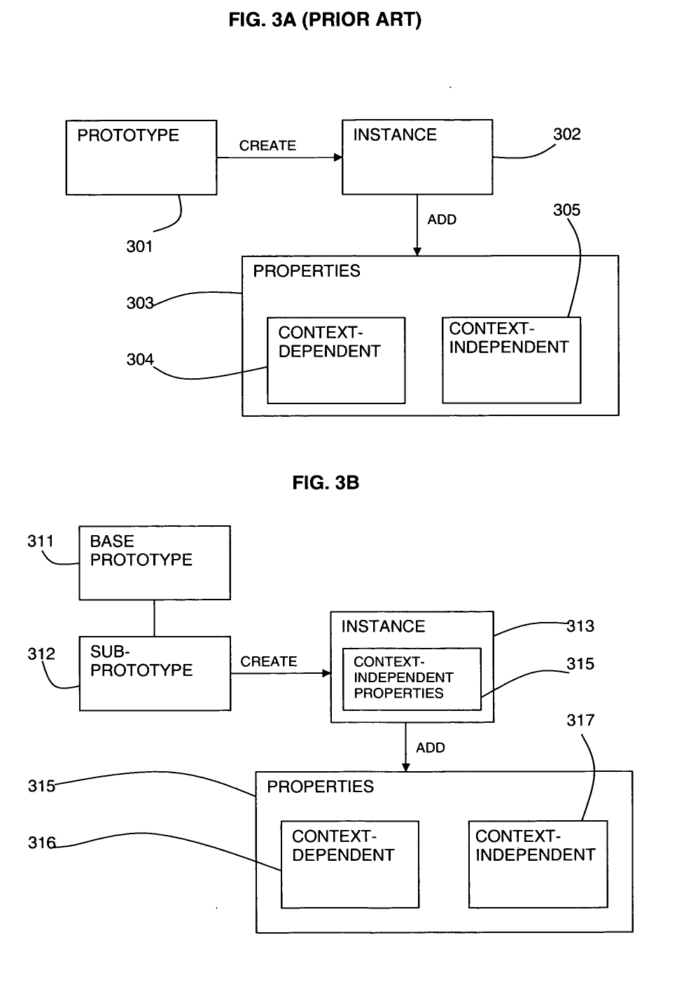

Referring to FIGS. 3A and 3B, the use of a prototype from a pallet is illustrated schematically. FIG. 3A shows the use of a prototype 301 as known in the prior art. A prototype 301 provided in a pallet is used to create an element instance 302 on an edit area. The element instance 302 has properties 303 which can be defined in the form of context-dependent properties 304 and context-independent properties 305. The properties 303 may be defined by the user, or automatically by the visual editor application. For example, the location properties are defined automatically when a user positions the element instance 302 in the edit area. The context-dependent properties 304 are individual to the element instance 302 as they relate to the context in which the element instance 302 is provided such as its location in the edit area and its relation to other elements. The context-independent properties 305 relate to properties of the element which can be applied to another element instance.

In FIG. 3B, a prototype method is provided in accordance with the present invention. A base prototype 311 has a plurality of sub-prototypes 312 provided in a pallet which can be used to create an element instance 313 on an edit area. The sub-prototype 312 already has some context-independent 314 properties defined. In addition, further properties 315 can be defined for the element instance 313 in the form of context-dependent properties 316 and context-independent properties 317.

An element instance 313 with defined context-dependent properties 316 can be added to the sub-prototype set to create a new sub-prototype 312. A new sub-prototype created in this way may be saved in the sub-prototype set for the duration of the current project or in the user's stored copy of the visual editor application in which the pallet is provided. A new sub-prototype may be a complex combination of more than one base prototype.

Implementing a system in which sub-prototypes are provided depends on the specific user interface toolkit utilized by the application. Most user interface toolkits provide functionality for customizing pallets and for creating pop-up menus and therefore, the sub-prototypes can be provided in this way.

The following is an example embodiment of one possible implementation.

A conventional pallet concept includes only two levels: a first level for the pallet entities; and a second level for the pallet instances. To support pallet entities with a configuration enabling sub-prototype use, a third level is added. This third level will be used for the pallet entities meta-data.

The three levels are:

Base prototype level—This is the pallet meta-data level. This level contains all the pallet base properties, created by the tool developer or by the tool descriptor in advanced versions.

Sub-prototype level—This is the pallet entities level. Each entry in this level is a prototype that the user can easily drag to the edit area to instantiate new cloned instance of it. Those entities can be created both by the tool developer and the tool end-user. The tool developer can define a default pallet entity and other pallet entities that she thinks the current tool driver should include to be matched to specific industry end users' needs.

Instances level—This is the instances level contains all the pallet instances created by the tool end user. Note that this level includes all the actual shapes that are part of the end-user created paint.

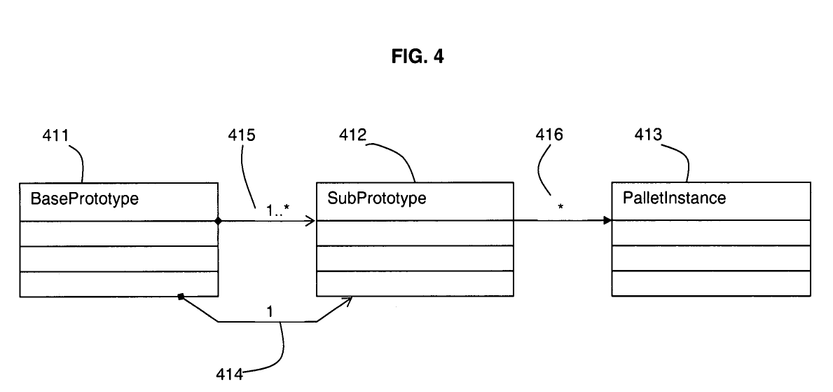

This is illustrated in FIG. 4 which shows the three levels of a pallet entry of a base prototype level 411, a sub-prototype level 412, and a pallet instance level 413.

The base prototype level 411 is a set of pallet entities meta-data. The base prototype defines the prototype meta-data. In addition, it defines the default values for those properties. The base prototype has a non-empty list of sub-prototypes. The tool developer can define which of the sub-prototypes are configurable and which are not. This enables a good way to define a tool predefined sub-property for each base property. One of the sub-prototypes is the default one 414. This default sub-prototype 414 will be used when the user drags a pallet entity from the pallet to the edit area in the regular way. The sub-prototype is a configured instance of base prototype.

Each base prototype has one or more sub-prototypes 415, one of which is the default 414. Each sub-prototype can have multiple pallet instances 416.

The instances level 413 includes all the specific pallet entity instances. This could be implemented in two ways. The first is more efficient way in which each sub-prototype is an instance of base prototype that is already defined in the memory and once the user select it, a clone instance is created. The second way is to store only the configuration changes and while the user selects the sub-property entry in the pallet the associated base prototype is cloned and the cloned object is configured according to the configuration changes in the sub-prototype.

The tool can store the pallet entities defined by the user in the tool meta-data or in the scope of the current project.

To illustrate an example is provided. A user is creating a road map using a drawing application with the described sub-prototype pallet provided.

In the drawing application there is a predefined pallet entry for a “connector” base prototype. When instantiated between two points, a base connector looks like two adjacent parallel lines spanning the distance between the two points. The base prototype supports three context-independent properties: thickness (the distance between the parallel lines); line color (the color of the two lines); and fill color (determines the color between the two lines). The default values are a thickness of zero (no distance), black line color, and a black fill color. Thus, elements created on the edit area would appear simply as solid lines. Nevertheless, the user can then select the element on the edit area, change its fill color to white and increase its thickness, and obtain a parallel-line shape similar to that used for many purposes, including major roads on a map. By changing the line color as well, different highway types could be created.

In addition, the pallet entry for the “connector” base prototype has a small arrow in its corner. When the mouse pointer is on it for more than approximately 0.5 of a second, a small pop-up menu appears adjacently, revealing a sub-prototype. This sub-prototype is similar to the base connector, but has a preset thickness of 2 and a white fill color. If the user selects this sub-prototype instead of the base prototype and drags it into the edit area, she will have the road and only need to change its color.

The user starts drawing the road map, creating roads by taking the sub-prototype and changing thickness and line color. She now has three primary road types: blue, green and red, each with specific thickness. To create elements of these same types, she could use implicit prototyping and duplicate the existing roads, or take the sub-prototype and change properties. Instead, she right clicks on each road and selects “add prototype” in the resulting context-sensitive menu. By doing so, she has augmented the list of available sub-prototypes of the “connector” with the specific road types, and can now simply drag these roads into the edit area to create the appropriate elements.

In the example above, the connector is a base prototype. The connector defines three context-independent properties: thickness (the distance between the parallel lines), line color (the color of the two lines), and fill color (determines the color between the two lines). A simple road with zero thickness is a predefined sub-prototype of the connector base prototype. The other types of roads are also sub-prototypes of the connector base prototype but are a user defined sub-prototypes.

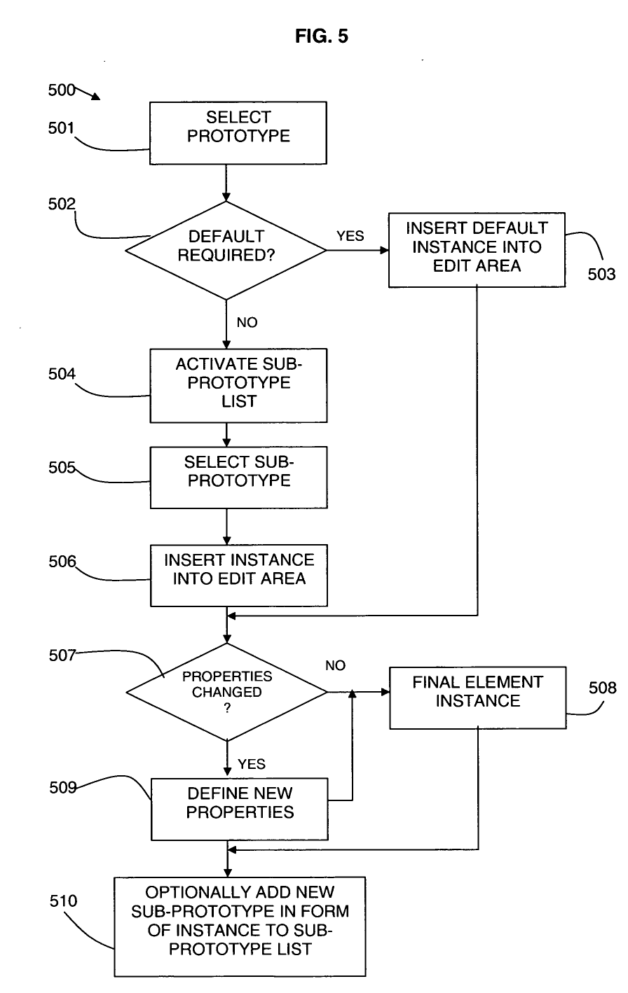

Referring to FIG. 5, a flow diagram 500 shows the steps a user may take when using a sub-prototype. A base prototype is selected from the pallet 501. Determine if the default prototype is required 502. If so, insert default prototype instance into edit area 503. If the default prototype is not required, access the menu of sub-prototypes 504 and select a sub-prototype 505 and insert it into the edit area 506.

It is determined if the context-independent properties of the inserted instance are to be changed 507. If not, the final element instance is formed 508. If so, the properties are defined 509 and the final element instance formed 508.

Optionally, if the context-independent properties are changed 509, the instance can be added as a new sub-prototype in the sub-prototype menu 510.

The pallet meta-data can be defined in a separate artifact and then can be used as a pallet style template. The concept of a style template enables more freedom. For example, a graphic group can define their own pallet style template. This can ensure that all the projects created with the tool use common building blocks and accelerate the development process.

The tool can be delivered with several sets of pallet meta-data. The tool could be delivered for different industries and each industry supplied with the tool with the set of pallet entities that are matched to the specific needs.

There are many ways to implement the three level pallet mechanisms in the GUI. In one embodiment, the pallet classes are pallet entries while the pallet entities can be displayed by a right click on the pallet entry. Another embodiment is to create a small button for the pallet entry that will open a list of pallet entities. There are many other options.

This solution can be extended to support complex pallet entries. For example, the user may draw two bold lines and one dashed line in the middle. Then we could group the shapes together and add the group as a pallet entry as a regular atomic entry.

The advantages of this approach include providing useful built in sub-prototypes without cluttering the primary pallet, eliminating the need for time-consuming implicit prototyping, supporting collaboration between different team members, and supporting the creation of document templates.

The present invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk-read only memory (CD-ROM), compact disk-read/write (CD-R/W) and DVD.

Improvements and modifications can be made to the foregoing without departing from the scope of the present invention.

We claim:

1. A system for providing visual editing elements, comprising:
a base prototype of an element including meta-data properties of the element;
at least one sub-prototype associated with the base prototype with defined meta-data properties; and
wherein the sub-prototype is selectable by a user to create an element instance.

2. A system as claimed in claim 1, wherein the system includes means to add an element instance as a new sub-prototype.

3. A system as claimed in claim 2, wherein new sub-prototypes are stored in the system.

4. A system as claimed in claim 2, wherein new sub-prototypes are stored in association with a current document in which the element instances are created.

5. A system as claimed in claim 1, wherein the base prototype is selectable by a user and one of the sub-prototypes is provided as a default sub-prototype.

6. A system as claimed in claim 1, wherein the meta-data are context-independent properties of an element.

7. A system as claimed in claim 1, wherein the sub-prototypes are configurable to create an element instance.

8. A system as claimed in claim 1, wherein the sub-prototypes are complex forms made up more than one base element.

9. A system as claimed in claim 1, wherein different sets of meta-data properties are provided for a base prototype.

10. A tool for providing visual editing elements, comprising:
a plurality of base prototypes of elements, each base prototype providing meta-data properties of the element;
at least one sub-prototype associated with the base prototype with defined meta-data properties; and
wherein the sub-prototype is selectable by a user to create an element instance.

11. A tool as claimed in claim 10, wherein the tool is a graphical user interface component.

12. A tool as claimed in claim 11, wherein the tool is a toolbar.

13. A tool as claimed in claim 10, wherein the base prototypes have an expanding means to show representations of the at least one sub-prototype.

14. A method for providing visual editing elements, comprising:
providing a base prototype of an element including meta-data properties of the element;
providing at least one sub-prototype associated with the base prototype with defined meta-data properties; and
selecting a sub-prototype to create an element instance.

15. A method as claimed in claim 14, wherein the method includes means for adding an element instance as a new sub-prototype.

16. A method as claimed in claim 14, including selecting the base prototype and defaulting to one of the sub-prototypes.

17. A method as claimed in claim 14, including configuring the sub-prototypes to create an element instance.

18. A computer program product stored on a computer readable storage medium, comprising computer readable program code means for performing the steps of:
providing a base prototype of an element including meta-data properties of the element;
providing at least one sub-prototype associated with the base prototype with defined meta-data properties; and
selecting a sub-prototype to create an element instance.
